(19) United States
(12) Patent Application Publication
(10) Pub. No.: US 2019/0095107 A1
(43) Pub. Date: Mar. 28, 2019

(54) DATA CLASSIFICATION FOR PLACEMENT WITHIN STORAGE DEVICES

(71) Applicant: Intel Corporation, Santa Clara, CA (US)

(72) Inventors: Michal WYSOCZANSKI, Koszalin (PL); Andrzej JAKOWSKI, Gdansk (PL); Kapil KARKRA, Chandler, AZ (US)

(21) Appl. No.: 15/717,987

(22) Filed: Sep. 28, 2017

(51) Int. Cl. G06F 3/06; G06F 12/0871; G06F 12/0853; G06F 17/30

(52) U.S. Cl. CPC G06F 3/0611; G06F 3/0631; G06F 3/0679; G06F 17/30707; G06F 12/0853; G06F 3/0616; G06F 12/0871

(57) ABSTRACT

Systems and methods for issuing one or more write requests to a storage device, the system comprising one or more processors configured to generate one or more write requests, each write request comprising a respective data; tag each of the one or more write requests as a respective class from a plurality of classes, wherein the plurality of classes categorize data based on a rate at which it is written to the storage device; and issue the one or more write requests with their respective tags to the storage device, wherein the tag indicates to the storage device to write the first data proximate to data of the respective class within the storage device.

### TECHNICAL FIELD

Various aspects relate generally to data caching technologies.

### BACKGROUND

As modern technologies become more reliant on vast amounts of acquired data acquired from multiple components of a network infrastructure, methods and devices for efficiently handling and storing the data are needed to accommodate the ever-increasing data volume and data traffic. The use of solid states drives (SSDs) for storing data is becoming increasingly popular as the price for SSDs continues to drop while providing numerous advantages over their hard-disk drive (HDD) predecessors, such as, faster access times, greater reliability and increased lifespan. However, current host-based caching methods using SSDs do not maximize the benefits that SSDs offer.

Recent advancements in Non-Volatile Memory (NVM) technologies and standards offer more flexibility for a host to control internal data placement within an SSD, e.g. in the NVM Express (NVMe) standard, the “Streams Directive” allows for a host to tag write commands with a stream identifier to instruct the SSD to place the data in separate units, each unit associated with the respective identifier.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating the principles of the invention. In the following description, various embodiments of the invention are described with reference to the following drawings, in which:

FIG. 1 shows a schematic view of a storage system, according to various aspects;

FIG. 2 shows a data plane view of a storage system according to some aspects;

FIG. 3 shows a management plane view of a storage system according to some aspects;

FIG. 4 shows a graph and a chart showing advantages of data classification according to some aspects;

FIG. 5 is a schematic diagram of a cache storage system according to some aspects;

FIG. 6 is a schematic diagram of a cache storage controller according to some aspects;

FIG. 7 is a flowchart describing a method according to some aspects; and

FIG. 8 is a flowchart describing a method according to some aspects.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments. Various embodiments are described in connection with methods and various embodiments are described in connection with devices. However, it may be understood that embodiments described in connection with methods may similarly apply to the devices, and vice versa.

The terms “at least one” and “one or more” may be understood to include any integer number greater than or equal to one, i.e. one, two, three, four, [ . . . ], etc. The term “a plurality” may be understood to include any integer number greater than or equal to two, i.e. two, three, four, five, [ . . . ], etc.

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and the claims expressly refer to a quantity greater than one. Accordingly, any phrases explicitly invoking the aforementioned words (e.g., “a plurality of [objects],” “multiple [objects]”) referring to a quantity of objects expressly refers more than one of the said objects. The terms “group (of),” “set [of],” “collection (of),” “series (of),” “sequence (of),” “grouping (of),” etc., and the like in the description and in the claims, if any, refer to a quantity equal to or greater than one, i.e. one or more.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer.

The term “processor” or “controller” as for example used herein may be understood as any kind of entity that allows handling data. The data may be handled according to one or more specific functions executed by the processor or controller. Further, a processor or controller as used herein may be understood as any kind of circuit, e.g., any kind of analog or digital circuit. The term “handle” or “handling” as for example used herein referring to data handling, file handling or request handling may be understood as any kind of operation, e.g., an I/O operation, as for example, storing (also referred to as writing) and reading, or any kind of logic operation.

A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

In current technologies, differences between software and hardware implemented data handling may blur, so that it has to be understood that a processor, controller, or circuit detailed herein may be implemented in software, hardware or as hybrid implementation including software and hardware.

The term “system” (e.g., a storage system, a server system, client system, guest system etc.) detailed herein may be understood as a set of interacting elements, wherein the elements can be, by way of example and not of limitation, one or more mechanical components, one or more electrical components, one or more instructions (e.g., encoded in storage media), one or more processors, and the like.

The term “storage” (e.g., a storage device, a primary storage, etc.) detailed herein may be understood as any suitable type of memory or memory device, e.g., a hard disk drive (HDD), and the like.

The term “cache storage” (e.g., a cache storage device) or “cache memory” detailed herein may be understood as any suitable type of fast accessible memory or memory device, a solid-state drive (SSD), and the like. According to various embodiments, a cache storage device or a cache memory may be a special type of storage device or memory with a high I/O performance (e.g., a great read/write speed, a low latency, etc.). In general, a cache device may have a higher I/O performance than a primary storage, wherein the primary storage may be in general more cost efficient with respect to the storage space. According to various embodiments, a storage device may include both a cache memory and a primary memory. According to various embodiments, a storage device may include a controller for distributing the data to the cache memory and a primary memory.

As used herein, the term “memory”, “memory device”, and the like may be understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D crosspoint (3D XPoint™), etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component comprising one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

A volatile memory may be a storage medium that requires power to maintain the state of data stored by the medium. Non-limiting examples of volatile memory may include various types of RAM, such as dynamic random access memory (DRAM) or static random access memory (SRAM). One particular type of DRAM that may be used in a memory module is synchronous dynamic random access memory (SDRAM). In some aspects, DRAM of a memory component may comply with a standard promulgated by Joint Electron Device Engineering Council (JEDEC), such as JESD79F for double data rate (DDR) SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

Various aspects may be applied to any memory device that comprises non-volatile memory. In one aspect, the memory device is a block addressable memory device, such as those based on negative-AND (NAND) logic or negative-OR (NOR) logic technologies. A memory may also include future generation nonvolatile devices, such as a 3D XPoint™ memory device, or other byte addressable write-in-place nonvolatile memory devices. A 3D XPoint™ memory may comprise a transistor-less stackable cross-point architecture in which memory cells sit at the intersection of word lines and bit lines and are individually addressable and in which bit storage is based on a change in bulk resistance.

In some aspects, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magneto resistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The terms memory or memory device may refer to the die itself and/or to a packaged memory product.

The disclosure herein presents a host based caching on SSD implemented software that categorizes and tags different classes of data which differ in lifetime, for example: user data, cache metadata (static and dynamic), etc. By separating these classes of data for storage within a NAND SSD, data movement within the SSD is lessened, thereby increasing SSD endurance and performance as observed by the host.

In NAND flash memory, memory cells are grouped blocks, each block consisting of a group of pages. The smallest unit through which a block can be read or written is a page, i.e. read and write operations are performed at a page-level granularity. The page size may vary, e.g. from 2 KB to 16 KB, and a block may include a plurality of pages, e.g. 128, 256, etc. While pages may be written and read individually, they may not be erased (and therefore, modified or updated) individually, and are instead erased by the block, i.e. the erase operation is performed at a block-level granularity.

According to some aspects, methods and algorithms are presented by which a host based caching solution classifies types of data for allocating within blocks of an SSD to minimize internal data movement within the SSD. Write commands received from an application/host are tagged with an identifier in order to distinguish among the different classes of data. In an exemplary aspect, the Cache Acceleration Software (CAS) identifies three classes of data from write requests: user data, static cache metadata, and dynamic cache metadata. Whenever the CAS writes data from one of these requests into the SSD, it tags the write commands with the appropriate identifier representing the class of data.

According to some aspects, a method and/or system configured to issue a write request to a storage device by; tagging the write request as a respective class from a plurality of classes, wherein the plurality of classes categorize data based on a frequency (i.e. rate) at which it is written (e.g. updated) to the storage device; and issue the write request with its respective tag to the storage device, wherein the respective tag signals to the storage device to write the first data proximate to data of the respective class.

According to some aspects, a method and/or system configured to allocate data on a storage device, the system comprising one or more processors configured to receive a write request comprising a first data; identify the write request as a respective class from a plurality of classes, wherein the plurality of classes categorize respective data based on the respective data's expected lifetime on the storage device; determine a first block on the storage device corresponding to the respective class, wherein the first block is distinct from other blocks on the storage device corresponding to other classes from the plurality of classes; and write the first data to the first block. Furthermore, one or more non-transitory computer-readable media storing instructions thereon that, when executed by at least one processor, direct the at least one processor to perform a method of allocating data on a storage device in order to perform this method.

According to some aspects, a caching software is provided to tag a user (i.e. application) I/O request (e.g. a Put, or write request) with a class from a plurality of classes, wherein the distinction between the classes is the anticipated lifetime of the data from the I/O request on SSD. In this manner, the caching software is able to provide to the SSD controller with information for more efficiently allocating the data to memory to minimize internal data movement, e.g. when data is updated or modified. Furthermore, the caching software is configured to similarly tag internally generated metadata requests (either static or dynamic) and issue the appropriately tagged metadata requests to the SSD. For example, by using the Streams Directive provided by the SSD according to NVMe standards, it is possible to assign a separate stream identifier to each type of metadata (i.e. static and dynamic) and to user data. This allows the SSD to allocate the data to separate erase units (i.e. NAND blocks, wherein each block includes a plurality of pages, where pages may be written and read individually, but are erased by the block, i.e. the erase operation is performed at a block-level granularity). Having the data separated reduces the erase unit fragmentation thus minimizing data movement within the SSD.

The metadata (either static or dynamic) is an internal state of the caching software configured for caching write requests, i.e. the I/O requests containing metadata write requests are never sent directly by the user/application, although in the case of dynamic metadata requests, may be a byproduct of a user I/O request. The I/O requests containing metadata are internally generated by the caching software during the process of handling user I/O requests or from cache management operations.

By implementing the methods and algorithms described herein, the write amplification factor (WAF) can be minimized, resulting in improved SSD endurance, improved performance as viewed by the host, improved Quality of Service (QoS), and potential power savings due to minimized duplicated Garbage Control (GC) logic in the host software and in the SSD.

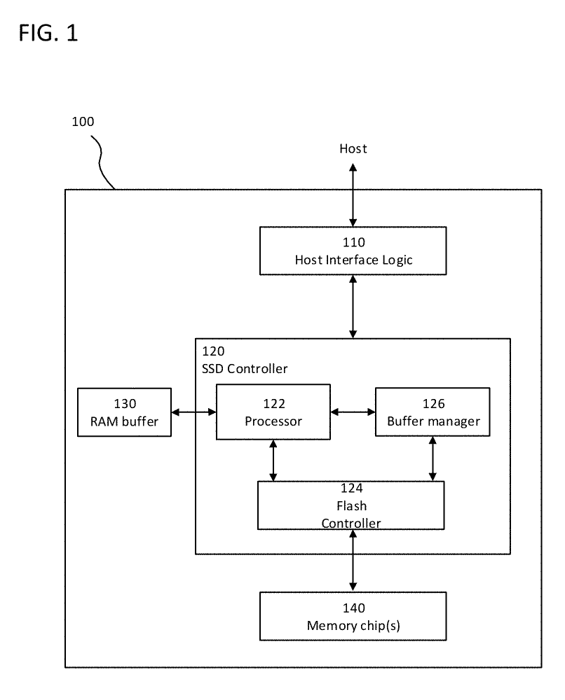

FIG. 1 shows a schematic diagram for a SSD architecture 100. It is appreciated that SSD architecture 100 is exemplary and thus may be simplified for purposes of this explanation.

The host interface logic 110, along with the associated connectors, is incorporated into the SSD and may include logic for supporting one or more logical interfaces, such as, for example, NVM Express (NVMe), Advanced Host Controller Interface (ACHI), ATAPI, etc. Host interface logic 110 is implemented to define the command sets used by operating systems to communicate with the SSD 100.

The SSD controller 120 is configured, through its components (Processor 122, Buffer manager 126, and the Flash controller 124, as well as RAM buffer 130) to execute firmware level code to perform a variety of functions, including bad block mapping, read and write caching, encryption, error detection and correction, garbage collection, read scrubbing and read disturb management, wear leveling, etc.

The memory chip(s) 140 may include one or more flash memory components, e.g. NAND flash chips configured to store data.

Typical caching solutions uses two kinds of metadata: static metadata that is rarely written, e.g. written only during management operations such as starting or stopping the cache, and dynamic metadata which is updated with user initiated I/O requests. These types of metadata have a distinctly different lifetimes, i.e. the amount of time they reside on the memory prior to being erased or modified.

By tagging and classifying this data, and possibly other types of data (e.g. user data), it is possible to provide storage devices, such as SSDs configured with the Streams Directive according to NVMe standards, with information to allow the storage devices to store the data in a more efficient manner.

In some aspects, the SSD 100 may use NVMe as the logical device interface for accessing the storage media (i.e. memory chips 140). NVMe allows the host hardware and software to fully exploit the levels of parallelism available in SSDs, resulting in a reduced I/O overhead and other performance improvements compared to previous logical-device interfaces. The Cache Acceleration Software (CAS) methods and algorithms presented in this disclosure exploit the benefits provided by NVME, e.g. the Streams Directive, in order to improve overall system performance.

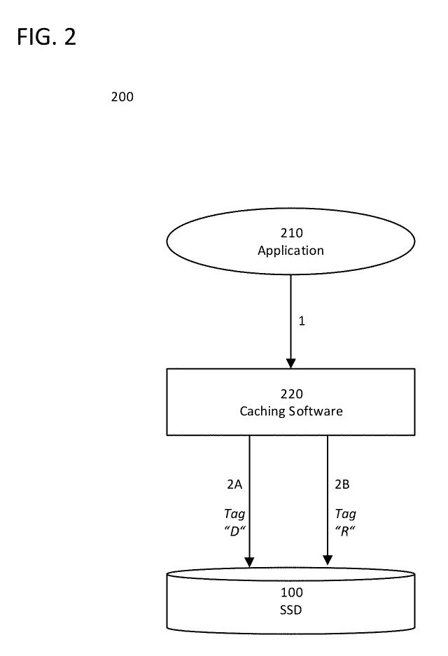

FIG. 2 shows a schematic diagram of a data plane 200 of a storage system in some aspects. It is appreciated that FIG. 2 is exemplary in nature and may thus be simplified for purposes of this explanation.

When a user issues a write request 1 through the application 210, the Caching software 220 performs two writes: a metadata update with cache mapping and cache line status 2A; and a cache line update 2B.

In contrast to current software implementations, which treat both writes in the same manner, the caching software herein tags each of the writes with a separate stream identifications (ids). The caching software 220 tags the write associated with the metadata update with cache mapping and cache line status, i.e. the dynamic metadata, with a first tag, e.g. D; and the caching software 220 tags the cache line update, i.e. the user data, with a second tag, e.g. R.

Any other writes to dynamic metadata are subsequently classified with the appropriate stream id, e.g. D. The tagging of the different types of data by the caching software 220 especially applies for a cleaner mechanism for flushing dirty data from the cache to the backend storage (not shown) which has to update dynamic metadata without writing user data.

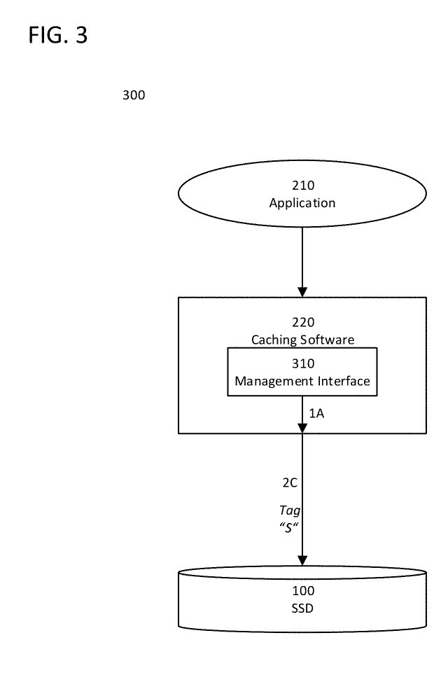

Similarly, the caching software 220 is able to tag any updates to static metadata with a unique stream id, i.e. a third tag, e.g. S. This is shown in FIG. 3 (showing the management plane 300 of the storage system in some aspects).

In FIG. 3, the management plane 300 of a storage system is shown according to some aspects. Aspects of management plane 300 are similar to those shown in FIG. 2, with the main difference being that this plane involves caching software 220 receiving management operation commands 1A (e.g. a cache start, cache stop, etc.) through a management interface 310 (e.g. input/output control (ioctrl), function call, etc.). The caching software processes this command and writes its internal state (i.e. configuration) to the cache device as static metadata 2C. Put differently, the static metadata requests do not directly originate from the user/application 210, but rather are internal requests generated from the caching software 220. Accordingly, the caching software 220 is also able to identify and tag 2C the static metadata, e.g. with a tag S.

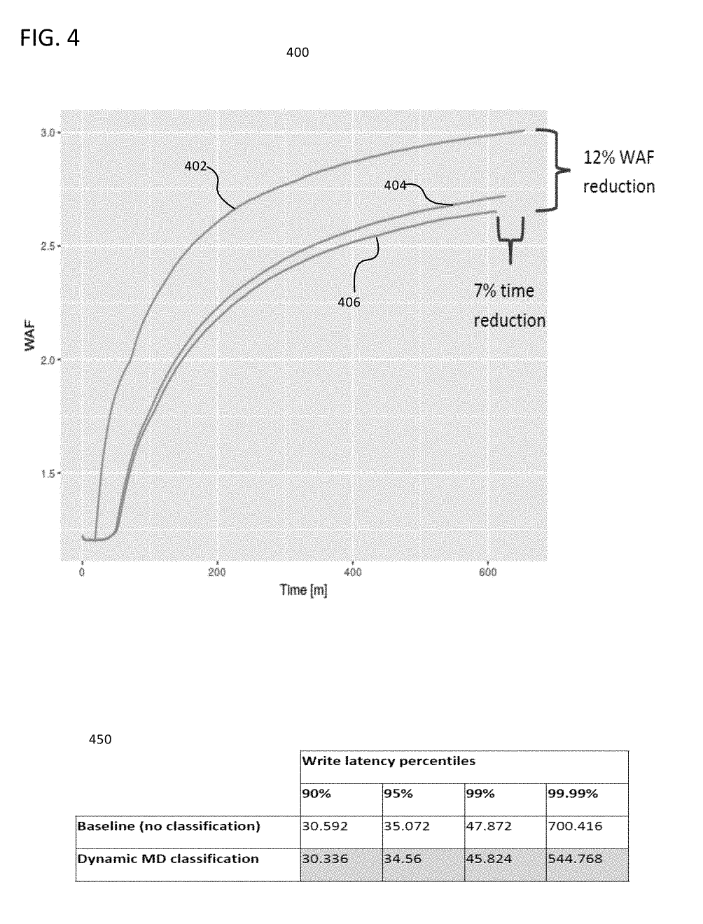

FIG. 4 is a graph 400 and a chart 450 showing the benefits of separating the different kinds of data in caching software in aspects of this disclosure. The x-axis is time and the y-axis is the write amplification factor (WAF). For the data shown by graph 400, the same dataset was written to an SSD using different Intel Cache Acceleration Software (CAS) algorithms as described below.

Two types of separation were considered and compared to a baseline in which the caching software did not perform the tagging of the different types of data, resulting in no separation of the data in the storage device. The results of this baseline are shown by line 402.

The line marked by 404 represents the CAS tagging of dynamic metadata only. In this implementation, the CAS assigned one stream identifier to the dynamic metadata while static metadata and user data were tagged with a stream identifier of 0, i.e. no classification. This resulted in the dynamic metadata being placed in separate erase units (i.e. blocks) than user data and static metadata altogether, i.e. the dynamic metadata was allocated to separate blocks of the SSD from the user data and static metadata. As can be seen from the graph 400, by separating only the dynamic metadata 404, both the WAF and time were reduced in writing the same dataset to SSD when compared to the baseline 402. Specifically, an observed decrease of about 10% in WAF (from 3.01 to 2.72) was observed.

The line marked by 406 represents the CAS tagging the static and dynamic metadata with distinct stream identifiers, in addition to the user data being assigned no stream identification. For example, the static metadata was tagged with an “S” (or a 1), the dynamic metadata was tagged with a “D” (or a 2), and the user data was tagged with a 0. This resulted in each of the three types of data being placed in a separate erase unit in the SSD. As can be seen from the graph 400, by separating of both static and dynamic from the user data, (shown by line 406), the WAF and time to write the same data set were reduced even further than when only the dynamic metadata was tagged 404. With respect to the baseline test, an approximately 12% reduction in WAF (from 3.01 to 2.65) and a 7% reduction in time to process the whole workload was observed.

Chart 450 shows QoS results comparing a CAS implementing classification algorithms according to some aspects of this disclosure to a baseline with no classification. The reported values are in microseconds. As can be seen from the chart 450, at four 9s, the classification of only dynamic metadata improves the tail latency by about 22% (from about 700 microseconds to about 545 microseconds).

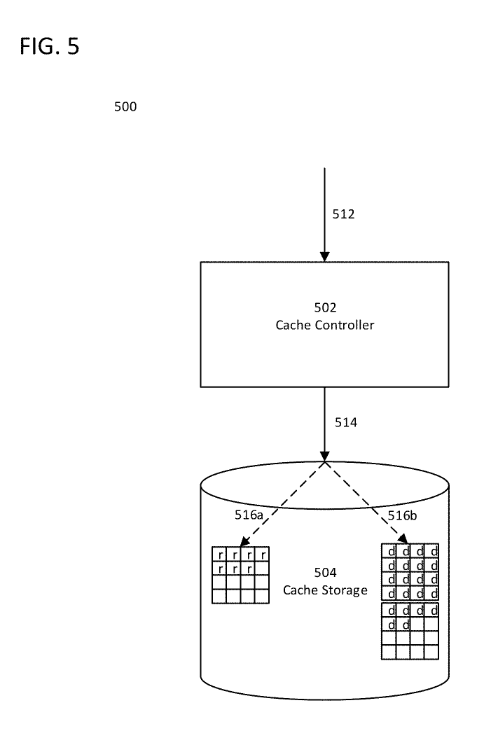

FIG. 5 is a schematic diagram of a cache storage system 500 according to some aspects. It is appreciated that cache storage system 500 is exemplary in nature and may thus be simplified for purposes of this explanation.

The cache controller 502 receives the I/O request 512 from a user, i.e. an application, host, etc. The cache controller 502 is configured to identify the data from the I/O request 512 as a respective class from a plurality of classes, and tag the I/O request with a tag corresponding to the respective class. The plurality of classes may include the classes discussed herein.

The cache controller 502 is further configured to issue the I/O request with its respective tag to the cache storage 504. The cache storage, through its own processors (not pictured), is configured to read the tag and write the data to a respective memory block, e.g. 516a (shown for user data, r) or 516b (shown for dynamic metadata, d), corresponding to data which has been similarly tagged. In this manner, data of the same type is proximately stored to one another (e.g. within the same block (erase unit)), thereby minimizing internal data movement upon the modification or updating of data, e.g. in an SSD. Similarly, static metadata originating from internal states of the caching software may be issued to Cache Storage 504 and stored in one or more respective block, i.e. erase units, distinct from those used for user data and dynamic data.

As shown in FIG. 5, a plurality of pages (each page represented as a small square) makes up an entire block (i.e. erase unit, each one represented in FIG. 5 as being composed of 16 pages). It is appreciated that these numbers and configurations are simplified for purposes of this explanation, and other values and numbers for the blocks and pages may be implemented depending on the configuration of the cache storage 504.

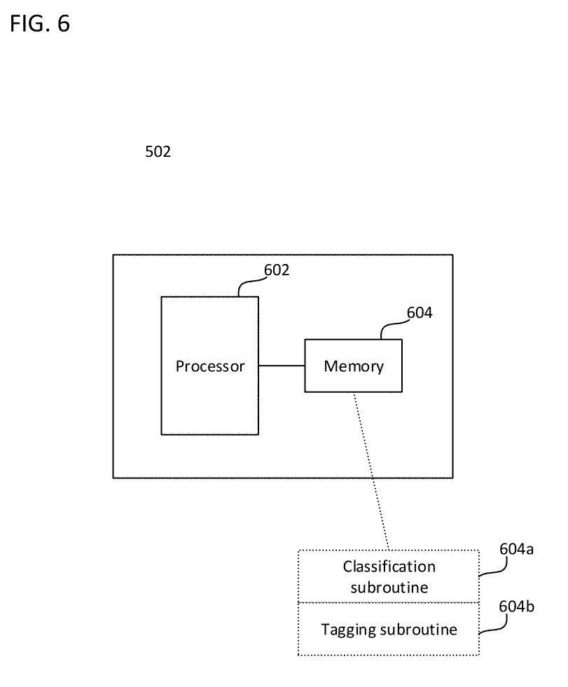

FIG. 6 is a schematic diagram of a cache storage controller 502 according to some aspects. It is appreciated that cache storage controller 502 is exemplary in nature and may thus be simplified for purposes of this explanation.

As shown in FIG. 6, controller 502 may include processor 602 and memory 604. Processor 602 may be a single processor or multiple processors, and may be configured to retrieve and execute program code to perform the transmission and reception, channel resource allocation, and cluster management as described herein. Processor 602 may transmit and receive data over a software-level connection that is physically transmitted as wireless signals or over physical connections. Memory 604 may be a non-transitory computer readable medium storing instructions for one or more of classification subroutine 604a and a tagging subroutine 604b.

Classification subroutine 604a and a tagging subroutine 604b may each be an instruction set including executable instructions that, when retrieved and executed by processor 602, perform the functionality of controller 502 as described herein. In particular, processor 602 may execute classification subroutine 604a to identify an write request as a type of data class from a plurality of classes of data (e.g. as R if a data request from a user/application; as D if a dynamic metadata request originating from the caching software either in response to a user request or a clean for flushing dirty data from cache to a backend storage (or any other update to dynamic metadata without writing a user data); as S if a static metadata request originating from the caching software); and processor 602 may execute tagging subroutine 604b to tag the write request with the respective tag of the identified class for issuing it to the storage device. While shown separately within memory 604, it is appreciated that subroutines 604a-604b may be combined into a single subroutine exhibiting similar total functionality, e.g. classification subroutine 604a and tagging subroutine 604c may be merged together into a single subroutine for identifying and tagging. By executing the one or more of subroutines 604a-604b, a cache storage controller may improve storage device endurance and QoS and performance as observed by the host.

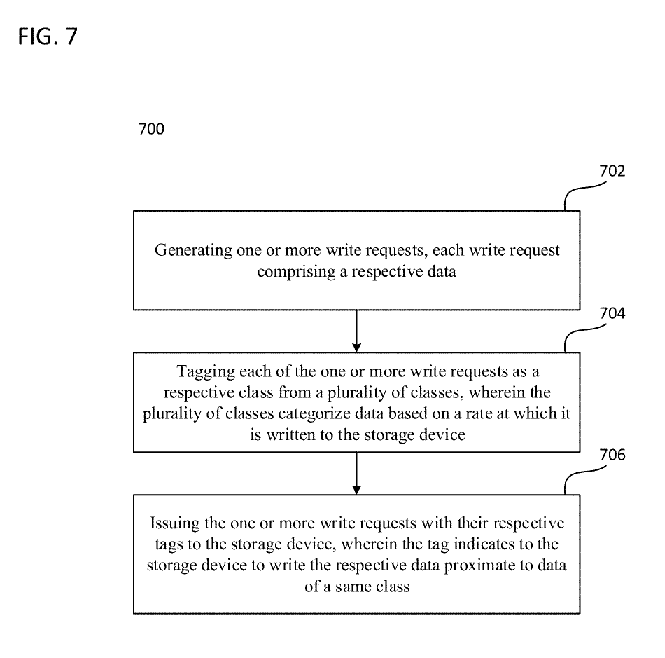

FIG. 7 is a flowchart 700 describing a method for issuing data to a storage device according to some aspects. It is appreciated that flowchart 700 is exemplary in nature and may thus be simplified for purposes of this explanation.

The methods described in flowchart 700 may be implemented by Cache Acceleration Software (CAS) for receiving a request from an application interface and issuing the write request to an SSD storage device configured according to NVMe standards.

First, one or more write requests are generated, each write request comprising a respective data 702. This respective data, for example, may include user data, static metadata, or dynamic metadata. Each of the one or more write requests are tagged as a respective class from a plurality of classes, wherein the plurality of classes categorize data based on a frequency (i.e. rate) at which it is written to (e.g. updated on) the storage device 704. For example, if the write request is a static metadata, the write request is tagged as such, since static metadata is updated far less frequently than either dynamic metadata or user input data received, for example, from an application interface.

Each of the one of more write requests is then issued, with its respective tag, to the storage device, wherein the respective tag indicates to the storage device to write the each respective data proximate to data of the respective class 706.

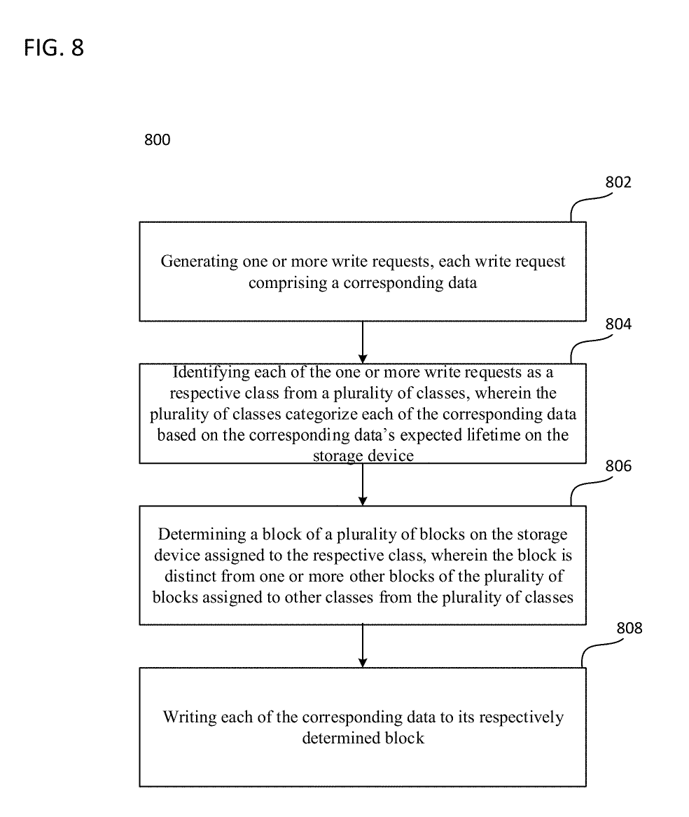

FIG. 8 is a flowchart 800 describing a method for allocating data on a storage device according to some aspects. It is appreciated that flowchart 800 is exemplary in nature and may thus be simplified for purposes of this explanation.

The storage system first generates one or more write requests, each write request comprising a corresponding data 802. This may be a user issued I/O request or a file to be stored, for example. Or, this may be a metadata request (either static or dynamic) issued from a caching software. Then, each of the one or more write requests is identified as a respective class from a plurality of classes, wherein the plurality of classes categorize respective data based on the respective data's expected lifetime on the storage device 804. For example, a write request including user data will have a distinctly different lifetime on the storage device than a write request including static metadata, i.e. the user data will be updated or modified with much greater frequency than static metadata.

A block (i.e. erase unit of an SSD) of a plurality of blocks on the storage device assigned to the respective class is determined, wherein the block is distinct from one or more other blocks of the plurality of blocks assigned to other classes from the plurality of classes 806.

Then, the corresponding data is written to its respectively determined block 808. For example, an SSD may assign each of the plurality of classes, e.g. user data, dynamic metadata, and static metadata, to different blocks (i.e. erase units) of the SSD. This will minimize internal data movement within the SSD upon modification and rewriting of already stored data.

In the following, various examples are provided with reference to the embodiments described above.

In Example 1, a system configured to issue a write request to a storage device, the system including one or more processors configured to generate one or more write requests, each write request comprising a respective data; tag each of the one or more write requests as a respective class from a plurality of classes, wherein the plurality of classes categorize data based on a rate at which it is written to the storage device; and issue the one or more write requests with their respective tags to the storage device, wherein the tag indicates to the storage device to write the first data proximate to data of the respective class within the storage device.

In Example 2, the subject matter of Example 1 may include wherein a first request of the one or more requests is generated in response to receiving an I/O request from an application interface.

In Example 3, the subject matter of Examples 1-2 may include wherein the plurality of classes comprises a first class and a second class.

In Example 4, the subject matter of Example 3 may include wherein the first class is a dynamic metadata class, wherein data belonging to the dynamic metadata class comprises metadata that is written with the I/O request from the application interface.

In Example 5, the subject matter of Example 3 may include wherein the first class is a dynamic metadata class, wherein data belonging to the dynamic metadata class comprises metadata request that is issued without the I/O request from the application interface.

In Example 6, the subject matter of Examples 4-5 may include wherein the dynamic metadata class comprises data including a cache mapping or a cache line status.

In Example 7, the subject matter of Examples 2-6 may include wherein the second class comprises all other types of data.

In Example 8, the subject matter of Examples 2-6 may include wherein the plurality of classes comprises a third class.

In Example 9, the subject matter of Example 8 may include wherein the second class is a static metadata class, wherein data belonging to the static metadata class comprises data about cache configuration.

In Example 10, the subject matter of Example 8 may include wherein the static metadata class comprises data which is generated by a management operation command describing an internal state of the system.

In Example 11, the subject matter of Examples 8-10 may include wherein the third data class is a user data class, wherein data belonging to the user data class comprises data write requests from received from an application interface.

In Example 12, the subject matter of Examples 1-11 may include wherein the storage device is a Solid State Drive (SSD).

In Example 13, the subject matter of Example 12 may include wherein the SSD is configured to implement a Streams Directive of the Non-Volatile Memory Express (NVMe) standard.

In Example 14, a method for issuing write requests to a storage device, the method including generating one or more write requests, each write request comprising a respective data; tagging each of the one or more write requests as a respective class from a plurality of classes, wherein the plurality of classes categorize data based on a rate at which it is written to the storage device; and issuing the one or more write requests with their respective tags to the storage device, wherein the tag indicates to the storage device to write the first data proximate to data of the respective class within the storage device.

In Example 15, the subject matter of Example 14 may include generating a first request of the one or more request in response to receiving an I/O request from an application interface.

In Example 16, the subject matter of Examples 14-15 may include wherein the plurality of classes comprises a first class and a second class.

In Example 17, the subject matter of Example 16 may include wherein the first class is a dynamic metadata class, wherein data belonging to the dynamic metadata class comprises metadata that is written with the I/O request from the application interface.

In Example 18, the subject matter of Example 16 may include wherein the first class is a dynamic metadata class, wherein data belonging to the dynamic metadata class comprises metadata request that is issued without the I/O request from the application interface.

In Example 19, the subject matter of Examples 17-18 may include wherein the dynamic metadata class comprises data including a cache mapping or a cache line status.

In Example 20, the subject matter of Examples 15-19 may include wherein the second class comprises all other types of data.

In Example 21, the subject matter of Examples 15-19 may include wherein the plurality of classes comprises a third class.

In Example 22, the subject matter of Example 21 may include wherein the second class is a static metadata class, wherein data belonging to the static metadata class comprises data about cache configuration.

In Example 23, the subject matter of Example 21 may include wherein the static metadata class comprises data which is generated by a management operation command describing an internal state of the system.

In Example 24, the subject matter of Examples 21-23 may include wherein the third data class is a user data class, wherein data belonging to the user data class comprises data write requests from received from an application interface.

In Example 25, the subject matter of Examples 14-24 may include wherein the storage device is a Solid State Drive (SSD).

In Example 26, the subject matter of Example 25, wherein the SSD is configured to implement a Streams Directive of the Non-Volatile Memory Express (NVMe) standard.

In Example 27, a system for allocating data on a storage device, the system including one or more processors configured to generate one or more write requests, each write request comprising a corresponding data; identify each of the one or more write requests as a respective class from a plurality of classes, wherein the plurality of classes categorize each of the corresponding data based on the corresponding data's expected lifetime on the storage device; determine a block of a plurality of blocks on the storage device assigned to the respective class, wherein the block is distinct from one or more other blocks of the plurality of blocks assigned to other classes from the plurality of classes; and write each of the corresponding data to its respectively determined block.

In Example 28, the subject matter of Example 27 may include wherein a first request of the one or more write requests is generated in response to an I/O request received from an application interface and comprises a user data.

In Example 29, the subject matter of Example 28 may include wherein the respective class is a user data class.

In Example 30, the subject matter of Examples 27-28 may include wherein at least one of the one or more write requests is a dynamic metadata write request and comprises dynamic metadata.

In Example 31, the subject matter of Example 30 may include wherein the dynamic metadata write request is generated in response to another write request of the one or more write requests, the other request comprising an I/O request received from an application interface.

In Example 32, the subject matter of Example 31 may include wherein the I/O request received from an application interface is identified as a first class from the plurality of classes and the dynamic metadata write request are identified as a second class from the plurality of classes.

In Example 33, the subject matter of Example 30 may include wherein the dynamic metadata write request is generated by an internal state of the system.

In Example 34, the subject matter of Examples 30-33 may include wherein the dynamic metadata write request comprises an update to a cache mapping or a cache line status.

In Example 35, the subject matter of Example 27 may include wherein at least one of the one or more write requests is a static metadata write request comprising static metadata.

In Example 36, the subject matter of Example 35 may include wherein the static metadata comprises data about cache configuration.

In Example 37, the subject matter of Examples 35-36 may include wherein the static metadata class comprises data which is generated by a management operation command describing an internal state of the system.

In Example 38, the subject matter of Examples 27-37 may include wherein the storage device is a Solid State Drive (SSD).

In Example 39, the subject matter of Example 38 may include wherein the SSD is configured to implement a Streams Directive of the Non-Volatile Memory Express (NVMe) standard.

In Example 40, the subject matter of Examples 27-39 may include wherein the plurality of classes comprise at least one of: a user data class, a dynamic metadata class, or a static metadata class corresponding to data which is written during data management operations.

In Example 41, the subject matter of Example 40 may include wherein the user data class comprises user initiated input requests.

In Example 42, the subject matter of Examples 40-41 may include wherein the respective class is a dynamic metadata class corresponding to metadata that is written with user initiated input/output (I/O) requests.

In Example 43, the subject matter of Example 42 may include wherein the dynamic metadata class comprises cache content information.

In Example 44, the subject matter of Example 43 may include wherein the cache content information comprises at least one of a cache mapping information or a cache line status.

In Example 45, the subject matter of Examples 40-44 may include wherein the static metadata class corresponding to information about a cache configuration.

In Example 46, the subject matter of Examples 40-45 may include wherein the static metadata class comprises data which is written during data management operations comprising at least one of starting cache or stopping cache.

In Example 47, the subject matter of Examples 45-46 may include wherein the static metadata class comprises at least one of a cache mode, used devices, or cleaning parameters.

In Example 48, the subject matter of Examples 27-47 may include the one or more processors configured to map the plurality of blocks of the storage device, each of the plurality of blocks configured to store data from one type of class from the plurality of classes.

In Example 49, a method for allocating data on a storage device, the method including generating one or more write requests, each write request comprising a corresponding data; identifying each of the one or more write requests as a respective class from a plurality of classes, wherein the plurality of classes categorize each of the corresponding data based on the corresponding data's expected lifetime on the storage device; determining a block of a plurality of blocks on the storage device assigned to the respective class, wherein the block is distinct from one or more other blocks of the plurality of blocks assigned to other classes from the plurality of classes; and writing each of the corresponding data to its respectively determined block.

In Example 50, the subject matter of Example 49 may include generating a first request of the one or more write requests in response to an I/O request received from an application interface and comprises a user data.

In Example 51, the subject matter of Example 50 may include wherein the respective class is a user data class.

In Example 52, the subject matter of Examples 48-49 may include wherein at least one of the one or more write requests is a dynamic metadata write request and comprises dynamic metadata.

In Example 53, the subject matter of Example 52 may include generating the dynamic metadata write request in response to another write request of the one or more write requests, the other request comprising an I/O request received from an application interface.

In Example 54, the subject matter of Example 53 may include identifying the I/O request received from an application interface as a first class from the plurality of classes and the dynamic metadata write request are identified as a second class from the plurality of classes.

In Example 55, the subject matter of Example 52 may include wherein the dynamic metadata write request is generated by an internal state of the system.

In Example 56, the subject matter of Examples 52-54 may include wherein the dynamic metadata write request comprises an update to a cache mapping or a cache line status.

In Example 57, the subject matter of Example 49 may include wherein at least one of the one or more write requests is a static metadata write request comprising static metadata.

In Example 58, the subject matter of Example 57 may include wherein the static metadata comprises data about cache configuration.

In Example 59, the subject matter of Examples 57-58 may include wherein the static metadata class comprises data which is generated by a management operation command describing an internal state of the system.

In Example 60, the subject matter of Examples 49-59 may include wherein the storage device is a Solid State Drive (SSD).

In Example 61, the subject matter of Example 60 may include wherein the SSD is configured to implement a Streams Directive of the Non-Volatile Memory Express (NVMe) standard.

In Example 62, the subject matter of Examples 49-61 may include wherein the plurality of classes comprise at least one of: a user data class, a dynamic metadata class, or a static metadata class corresponding to data which is written during data management operations.

In Example 63, the subject matter of Example 62 may include wherein the user data class comprises user initiated input requests.

In Example 64, the subject matter of Example 62-63 may include wherein the respective class is a dynamic metadata class corresponding to metadata that is written with user initiated input/output (I/O) requests.

In Example 65, the subject matter of Example 64 may include wherein the dynamic metadata class comprises cache content information.

In Example 66, the subject matter of Example 65 may include wherein the cache content information comprises at least one of a cache mapping information or a cache line status.

In Example 67, the subject matter of Examples 62-66 may include wherein the static metadata class corresponding to information about a cache configuration.

In Example 68, the subject matter of Examples 62-67 may include wherein the static metadata class comprises data which is written during data management operations comprising at least one of starting cache or stopping cache.

In Example 69, the subject matter of Examples 67-68 may include wherein the static metadata class comprises at least one of a cache mode, used devices, or cleaning parameters.

In Example 70, one or more non-transitory computer-readable media storing instructions thereon that, when executed by at least one processor, direct the at least one processor to perform a method or realize a system as in any preceding Example.

While the above descriptions and connected figures may depict device components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods/algorithms detailed herein are exemplary in nature, and are thus understood as capable of being implemented in a corresponding device. Likewise, it is appreciated that implementations of devices detailed herein are understood as capable of being implemented as a corresponding method and/or algorithm. It is thus understood that a device corresponding to a method detailed herein may include one or more components configured to perform each aspect of the related method.

All acronyms defined in the above description additionally hold in all claims included herein.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

What is claimed is:

1. A system for issuing one or more write requests to a storage device, the system comprising one or more processors configured to:
generate the one or more write requests, each write request comprising a respective data;
tag each of the one or more write requests as a respective class from a plurality of classes, wherein the plurality of classes categorize data based on a rate at which it is written to the storage device; and
issue the one or more write requests with their respective tags to the storage device, wherein the tag of each write request indicates to the storage device to write the respective data proximate to data of a same class.

2. The system of claim 1, wherein at least one request of the one or more requests is generated in response to receiving an I/O request from an application interface.

3. The system of claim 1, wherein the plurality of classes comprises a first class and a second class.

4. The system of claim 3, wherein the first class is a dynamic metadata class, wherein data belonging to the dynamic metadata class comprises metadata that is written with an I/O request from the application interface.

5. The system of claim 4, wherein the second class is a static metadata class, wherein data belonging to the static metadata class comprises data about cache configuration.

6. The system of claim 3, wherein the plurality of classes comprises a third class.

7. The system of claim 6, wherein the third data class is a user data class, wherein data belonging to the user data class comprises data write requests from received from an application interface.

8. A method for issuing one or more write requests to a storage device, the method comprising:
generating the one or more write requests, each write request comprising a respective data;
tagging each of the one or more write requests as a respective class from a plurality of classes, wherein the plurality of classes categorize data based on a rate at which it is written to the storage device; and
issuing the one or more write requests with their respective tags to the storage device, wherein the tag of each write request indicates to the storage device to write the respective data proximate to data of a same class.

9. The method of claim 8, wherein the plurality of classes comprises a first class and a second class.

10. The method of claim 9, wherein the first class is a dynamic metadata class and the second class is a user data class, wherein data belonging to the user data class comprises data from an I/O request received from the application interface.

11. The method of claim 9, wherein the plurality of classes comprises a third class.

12. The method of claim 11, wherein the third class is a static metadata class, wherein data belonging to the static metadata class comprises data about cache configuration.

13. The method of claim 12, wherein the static metadata class comprises data which is generated by a management operation command describing an internal state of the system.

14. A system for allocating data on a storage device, the system comprising one or more processors configured to:
generate one or more write requests, each write request comprising a corresponding data;
identify each of the one or more write requests as a respective class from a plurality of classes, wherein the plurality of classes categorize each of the corresponding data based on the corresponding data's expected lifetime on the storage device;
determine a block of a plurality of blocks on the storage device assigned to the respective class, wherein the block is distinct from one or more other blocks of the plurality of blocks assigned to other classes from the plurality of classes; and
write each of the corresponding data to its respectively determined block.

15. The system of claim 14, the one or more processors configured to:
map the plurality of blocks of the storage device, each of the plurality of blocks configured to store data from one type of class from the plurality of classes.

16. The system of claim 14, wherein at least one request of the one or more write requests is generated in response to an I/O request received from an application interface and comprises a user data.

17. The system of claim 14, wherein at least one of the one or more write requests is a dynamic metadata write request and comprises dynamic metadata.

18. The system of claim 17, wherein the dynamic metadata write request is generated in response to another write request of the one or more write requests, the other request comprising an I/O request received from an application interface.

19. The system of claim 14, wherein the plurality of classes comprises a user data class, a dynamic metadata class, and a static metadata class corresponding to data which is written during data management operations.

20. The system of claim 19, the one or more processors configured to assign at least one of the one or more write requests to the user data class, the dynamic metadata class, or the static metadata class.

21. One or more non-transitory computer-readable media storing instructions thereon that, when executed by at least one processor communicatively coupled to a storage device, direct the at least one processor to perform a method comprising:
generating the one or more write requests, each write request comprising a respective data;
tagging each of the one or more write requests as a respective class from a plurality of classes, wherein the plurality of classes categorize data based on a rate at which it is written to the storage device; and
issuing the one or more write requests with their respective tags to the storage device, wherein the tag of each write request indicates to the storage device to write the respective data proximate to data of a same class.

22. The one or more non-transitory computer-readable media of claim 21, the instructions further comprising instructions to generate at least one of the one or more requests in response to an I/O request received from an application interface.

23. The one or more non-transitory computer-readable media of claim 22, the instructions further comprising instructions to tag the respective data of the I/O request as a user data.

24. The one or more non-transitory computer-readable media of claim 23, the instructions further comprising instructions to generate a dynamic metadata request in response to the I/O request received from an application interface and tag it as a dynamic metadata.

25. The one or more non-transitory computer-readable media of claim 24, wherein the storage device is a Solid State Drive (SSD).
